(19) United States
(12) Patent Application Publication
(10) Pub. No.: US 2009/0304041 A1
(43) Pub. Date: Dec. 10, 2009

(54) Apparatus for the Determination of the Surface Moisture of a Test Object

(76) Inventors: Manfred Streicher, Lenzkirch (DE); Frank Eder, Eggingen (DE); Martin Rombach, Lenzkirch (DE); Martin Stratmann, Freiburg (DE); Andreas Messerschmid, Bonndorf-Gundelw (DE); Lars Hinkelmann, Lenzkirch (DE); Patrick Zahn, Eisenbach (DE); Karl Schuler, Titisee-Neustadt (DE)

Correspondence Address: MUIRHEAD AND SATURNELLI, LLC, 200 FRIBERG PARKWAY, SUITE 1001, WESTBOROUGH, MA, 01581, US

(21) Appl. No.: 11/992,717

(22) PCT Filed: Sep. 27, 2006
(86) PCT No.: PCT/EP2006/009380

§ 371 Date: Aug. 10, 2009

(30) Foreign Application Priority Data
Sep. 29, 2005 (DE) 202005015397.4

(51) Int. Cl. G01N 25/66; G08B 21/00

(52) U.S. Cl. 374/28; 340/604

(57) ABSTRACT

An apparatus for determining the moisture of a surface, particularly a wall surface device for determining a room dew point, a surface temperature device for determining the surface temperature by means of an infrared radiation measuring instrument, and an assembly for determining the surface moisture from the room dew point and the surface temperature.

### BACKGROUND INFORMATION

The present invention relates to a device for determining the surface moisture of a measured object.

For mold evaluations of measured objects such as closed rooms, it is essential to determine the surface moisture of the walls of the rooms. There is a multitude of measuring methods geared towards determining the dew point spread instead of determining the surface moisture. It should be taken into consideration, however, that at different room and wall temperatures a constant dew point spread limiting value results in different values of surface moisture so that from the dew point spread it cannot be established in a reliable manner whether there is a risk of mold formation on the wall.

To determine the surface moisture of a measured object, known moisture sensors, which must be applied directly to the surface, may be used to determine the ambient humidity in a room; a wait of multiple hours being required before performing the actual measurement in order to equalize the experimental conditions to one another. In particular, the moisture sensors must be protected from the influence of the ambient air for this purpose. Therefore, this method is complex and time-consuming.

Alternatively, the surface temperature of the wall may first be determined, from which the surface moisture may be calculated if the room temperature and the room moisture are additionally determined. A surface detector, which also has a long equalization time, is used to determine the surface temperature. In addition, the surface temperature must be determined at many different points of the measured object to be measured in order to be able to make reliable statements about the surface moisture.

The object of the present invention is therefore to provide a device for determining the surface moisture of a measured object which is simpler to handle, but has a higher precision.

The object of the present invention is achieved by a device for determining the surface moisture of a measured object according to claim 1 and using a method for determining the surface moisture according to claim 12.

Advantageous embodiments and refinements of the present invention are specified in the subclaims.

The device according to the present invention for determining the surface moisture of a measured object, in particular a wall surface, has a fifth device for determining the room dew point, and a third device for determining the surface temperature using an infrared radiation measuring unit, as well as a system for ascertaining the surface moisture from the room dew point and the surface temperature. An advantage of this device is that the surface temperature is determined without contact using an infrared radiation measuring unit, which is significantly faster and more precise than determining the surface temperature using a surface detector. It is thus possible in particular to scan large-area wall surfaces rapidly in regard to the surface temperature and thus determine the surface moisture rapidly at different points of the wall surface, so that it is directly obvious whether the risk of mold formation exists at any points of the wall because of too high a surface moisture.

Preferably the fifth device is provided with a first device for determining the air humidity and a second device for determining air temperature, the system being able to ascertain the room dew point from the air humidity and air temperature, in order to determine the room dew point in a simple and reliable manner.

Preferably, the device is provided with a fourth device for producing a warning signal, in particular an acoustic and/or visual warning signal, if a critical value for the surface moisture is exceeded. The critical value is assigned a magnitude such that if the surface moisture exceeds it, the risk of mold formation exists. In order to provide an alert of this risk, a warning signal is output so that when an inspection of a wall is performed over a large area without registering all values ascertained for the surface moisture, it may also be easily established whether the risk of mold formation exists anywhere on the wall. An optical warning signal, which lights up or starts flashing, can be an additional indicator.

The critical value for the surface moisture is preferably 80%, since the risk of mold formation already exists starting at this value. If not only the risk of mold formation, but also a possibly existing risk of corrosion is to be checked, a critical value for the surface moisture of 60% suggests itself.

In an especially preferred embodiment of the present invention, the system is capable of ascertaining a critical surface temperature from the critical value for the surface moisture and the room dew point. The critical surface temperature thus corresponds to the critical value for the surface moisture, it being possible to ascertain in an especially simple manner therefrom whether the risk of mold formation exists.

For this purpose, the system is preferably capable of ascertaining a critical dew point spread from the critical surface temperature and the surface temperature. In principle, the dew point spread is calculated as the difference between the room dew point, which is determined from air humidity and air temperature, and the surface temperature. The critical dew point spread is determined in the present case as the difference between the critical surface temperature and the actual surface temperature. On the basis of the critical dew point spread, it is thus immediately obvious whether the risk of mold formation currently exists or whether mold formation may possibly occur in the event of only slight temperature differences in the room and on the surface.

The infrared radiation measuring unit is preferably an infrared pyrometer or an infrared camera. An infrared pyrometer only records data precisely; an infrared camera allows easy measurement and inspection of large surfaces.

The device is preferably provided also with an optical camera for generating an image in the visible spectrum area, which will be referred to as a visual image hereon, making it easy for the user doing the evaluation of the provided data to know where the data have been recorded.

The device preferably has a display for displaying the measured values of the first, second, and third devices and/or the ascertained room dew point and/or the ascertained surface moisture and/or the critical surface temperature and/or the critical dew point spread, and/or the visual image and/or the infrared image so that an operator may read off the measured and ascertained values immediately and take suitable measures, if necessary.

In a preferred embodiment of the present invention the system is designed in such a way that it provides an overlay of the ascertained surface moisture and/or the critical surface temperature and/or critical dew point spread with a visual image and/or the infrared image, that can be shown on the display. The overlay may preferably be presented by the system in such a way that the visual image and/or the infrared image is optically highlighted section by section, especially by using colors or by flashing. The overlay enables the user to easily identify at which part of the examined measured object there is a risk of mold formation. The examined measured object can be directly recognized by the user in the visual image or the infrared image. In addition, the endangered areas will be marked by the corresponding graphical presentation, for example, in that the endangered areas of the measured objects are presented in another color or by flashing, so that the user can identify directly in which areas of the examined measured objects it would be necessary to take action. In particular, this overlay provides an optical warning signal.

The first and/or second devices are preferably linked to the system via radio contact, in order to avoid high cable complexity, and to make it possible to situate the first and/or the second device in a space separate from the system.

The method according to the present invention for determining the surface moisture (T_{Wallmois}) of a measured object, in particular a wall surface (6), has the following steps. The room dew point and the surface temperature are determined with the appropriate devices. In particular, the surface temperature is determined quickly and effectively with the help of a contact-free infrared radiation measuring sensor. Subsequently the surface moisture is ascertained from the room dew point and the surface temperature.

An exemplary embodiment of the present invention will be explained in detail on the basis of the following figure.

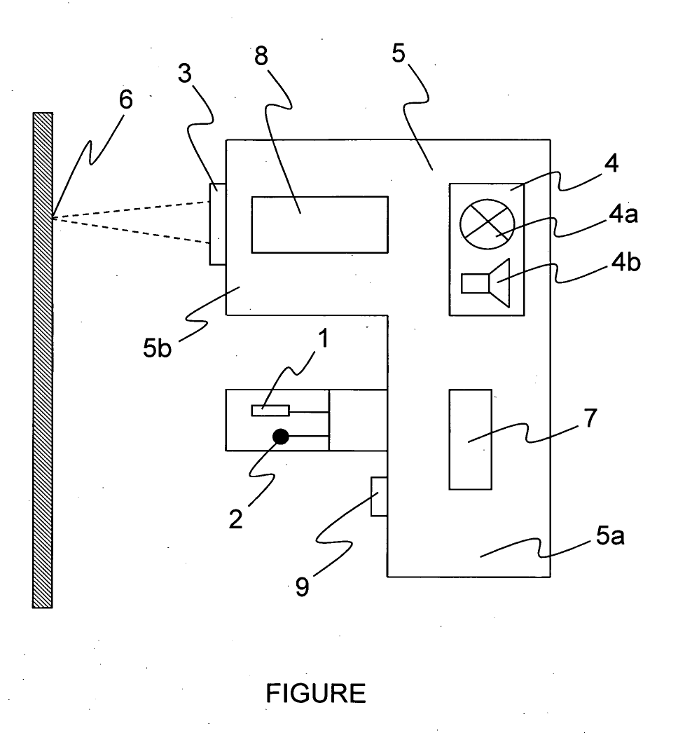

FIG. 1 shows a schematic view of an exemplary embodiment of a device according to the present invention.

FIG. 1 illustrates schematically an exemplary embodiment of a device which is implemented as measuring unit 5 in particular. Measuring unit 5 is shaped like a pistol having a handle 5a and a measuring head 5b, which is comparable to the pistol barrel.

A first device 1 for determining air humidity T_{Airhum}, which has a moisture sensor, for example, is situated below measuring head 5b in a carrier tube 5c through which air flows. Furthermore, a second device 2 for determining air temperature T_{Air} using a temperature sensor is situated in carrier tube 5c. A third device 3 for determining surface temperature T_{wall} of a wall surface 6 is located in measuring head 5b. Third device 3 has an infrared radiation measuring sensor, which detects the thermal radiation produced by wall surface 6 and may thus determine surface temperature T_{wall} of wall surface 6 rapidly without long equalization times. The infrared radiation measuring sensor may be an infrared pyrometer or an infrared camera. Finally, device 5 may be provided with another optical camera, not shown, to provide a visual image. The moisture sensor of first device 1 and the temperature sensor of second device 2 also have short response times, so that the measurement may be performed rapidly.

Measured values T_{Airhum}, T_{Air}, and T_{Wall} ascertained by first device 1, second device 2, and third device 3 and, if necessary, the visual images or the infrared image are relayed to system 7 via a radio link, which further processes and analyzes measured values T_{Airhum}, T_{Air}, and T_{Wall}. First, room dew point TP_{Room} existing in the room is determined from air humidity T_{Airhum} measured by first device 1 and air temperature T_{Air} measured by second device 2, for which the known Magnus formula is typically used. Surface moisture T_{Wallmois} is ascertained in system 7 from surface temperature T_{Wall} determined using third device 3 and ascertained room dew point TP_{Room} using the following approximation formula

$${T}_{Wallmois} = {( \frac{1.098 + \frac{{TP}_{Room}}{100}}{1.098 + \frac{{T}_{Wall}}{100}} )}^{8} ⋆ 100.$$

In an infrared pyrometer this analysis may be performed only for one point of the examined surface; however, the infrared measuring sensor is preferably designed as an infrared camera so that a plurality of pixels of an infrared image is analyzed.

For example, first device 1 ascertains an air humidity T_{Airhum} of 65% and air temperature T_{Air} measured using second device 2 is 21° C. First, a room dew point TP_{Room} of 14.2° C. results therefrom using the Magnus formula. Furthermore, a value of 18° C. for surface temperature T_{Wall} of wall surface 6 is ascertained using third device 3. From these values; system 7 ascertains a surface moisture T_{Wallmois} of 78.5% using the above approximation formula.

Measuring unit 5 preferably has a fourth device 4 for producing a visual and/or acoustic warning signal if a critical value T_{WallmoisCrit} for surface moisture T_{Wallmois} is exceeded. Critical value T_{WallmoisCrit} for surface moisture T_{Wallmois} is assigned a magnitude such that if this value T_{WallmoisCrit} is exceeded, a risk of mold formation on wall surface 6 exists. Fourth device 4 is equipped with an LED 4a and a loudspeaker 4b and connected to system 7 for this purpose. Typically, the use of one LED 4a or one loudspeaker 4b suffices. Critical value T_{WallmoisCrit} for surface moisture T_{Wallmois} may be stored in system 7 or directly in fourth device 4. This value is 80%, for example. If not only the risk of mold formation but rather also a possibly existing risk of corrosion is to be checked, a critical value T_{WallmoisCrit} for surface moisture T_{Wallmois} of 60% suggests itself. In the above-mentioned example, surface moisture T_{Wallmois} is at 78.5% and is thus below critical value T_{WallmoisCrit} of 80%, so that an output of a warning signal by LED 4a or loudspeaker 4b is not necessary, since the risk of mold formation is negligible. If critical value T_{WallmoisCrit} of 80% is exceeded, LED 4a may begin to light up or flash, or loudspeaker 4b may produce an acoustic signal once, multiple times, or continuously in order to notify the user of the risk of mold formation.

Furthermore, system 7 is equipped in such a way that it ascertains and stores a critical surface temperature T_{wallCrit} from critical value T_{WallmoisCrit} for surface moisture T_{Wallmois}. Critical surface temperature T_{WallCrit} represents the temperature of wall surface 6 at which, under the given conditions, surface moisture which corresponds to critical value T_{WallmoisCrit} or more may occur and the risk of mold formation may thus exist, and is determined at a critical value T_{WallmoisCrit} of 80% using the following approximation formula:

$${T}_{WallCrit} = ( \frac{1.098 + \frac{{TP}_{Room}}{100}}{0.9572} - 1.098 ) ⋆ 100.$$

In the present example, the resulting critical surface temperature T_{wallCrit} is 17.4° C. It is thus only 0.6° C. lower than previously ascertained actual surface temperature T_{Wall} of wall surface 6 of 18° C. The risk of mold formation could thus exist if wall temperature T_{Wall} of wall surface 6 is only slightly reduced. System 7 ascertains this difference of 0.6° C. as a critical dew point spread TP_{Crit} of critical surface temperature T_{WallCrit} and surface temperature T_{Wall}. It may be read off rapidly and easily on the basis of critical dew point spread TP_{Crit} whether the risk of mold formation currently exists and whether even slight changes in the room climate may possibly result in a risk of mold formation.

Furthermore, measuring unit 5 has a display 8 on which measured values T_{Airhum}, T_{Air}, and T_{Wall} measured by first device 1, second device 2, and third device 3, as well as values TP_{Room}, T_{wallmois}, T_{wallCrit}, and TP_{Crit} ascertained therefrom by system 7 may be displayed. The stored values such as critical value T_{WallmoisCrit} for surface moisture T_{Wallmois} may also be displayed on display 8. Display 8 may also have a function switch (not shown), using which the display may be switched over between different measured values T_{Airhum}, T_{Air}, and T_{Wall} or ascertained values, TP_{Room}, T_{wallmois}, T_{WallCrit}, and TP_{Crit}.

Display 8 may also be used for presenting a visual image or an infrared image and may send out optical warning signals in particular. Additional light-emitting diode 4a may then be eliminated. To that effect, system 7 overlays the visual image or the infrared image with the corresponding ascertained values TP_{Room}, T_{Wallmois}, T_{WallCrit}, TP_{Crit}. If, for example the visual image or the infrared image is overlain with a surface moisture image, which shows the surface moisture of every point in the image, or alternatively with a dew point spread image which shows the dew point, i.e., the difference between the room dew point TP_{Room}, calculated from the air humidity T_{Airhum} and air temperature T_{Air}, and the surface temperature T_{Wall}, for every point in the image, the user will be able to identify immediately, in which areas of the measured objects the risk of mold formation or precipitation of moisture exists. In particular, those areas of the measured object in which the critical value T_{WallmoisCrit} for the surface moisture T_{Wallmois} is exceeded or falls below a preset dew point spread, particularly the critical dew point spread TP_{Crit}, are optically highlighted with a corresponding color or through flashing, by which an optical warning signal is provided for the user, making the user aware that this area must be inspected.

Furthermore, measuring unit 5 has a switch 9 on handle 5a, using which measuring unit 5 may be turned on and off. The different measurements by first device 1, second device 2, and third device 3 may be started using switch 9 or a further switch (not shown). By scanning entire wall surface 6, it may be determined rapidly and easily whether the risk of mold formation exists at any points of wall surface 6.

### LIST OF REFERENCE NUMERALS

1 first device
2 second device
3 third device
4 fourth device
4a LED
4b loudspeaker
5 measuring unit
5a handle
5b measuring head
5c carrier tube
6 wall surface
7 system
8 display
9 switch
T_{Air} air temperature
T_{Airhum} air humidity
TP_{Room} room dew point
T_{Wall} surface temperature of the wall surface
T_{Wallmois} surface moisture of the wall surface
T_{WallCrit} critical surface temperature
T_{WallmoisCrit} critical surface moisture
TP_{Crit} critical dew point spread

1. A device for determining surface moisture of a surface, comprising:
a dew point device for determining room dew point;
a surface temperature device for determining surface temperature using an infrared radiation measuring unit; and
a system for ascertaining the surface moisture from the room dew point and the surface temperature.

2. The device as recited in claim 1, wherein the dew point device is provided with an air humidity device for determining air humidity and an air temperature device for determining air temperature, and wherein the system determines the room dew point from the air humidity and the air temperature.

3. The device as recited in claim 1, further comprising:
a warning device for producing a warning signal if a critical value for the surface moisture is exceeded.

4. The device as recited in claim 3, wherein the critical value for the surface moisture is 80%.

5. The device as recited in claim 3, wherein the system determines a critical surface temperature from the critical value for the surface moisture and the room dew point.

6. The device as recited in claim 5, wherein the system determines a critical dew point spread from the critical surface temperature and the surface temperature.

7. The device as recited in claim 1, wherein the infrared radiation measuring unit is at least one of: an infrared pyrometer and an infrared camera.

8. The device as recited in claim 1, further comprising:
an optical camera for providing a visual image.

9. The device as recited in claim 1, further comprising:
a display for displaying at least one of: air humidity, air temperature, the surface temperature, room dew point, the surface moisture, a critical surface temperature, a critical dew point spread, a visual image and an infrared image.

10. The device as recited in claim 9, wherein the system provides an overlay of at least one of: the surface moistures the critical surface temperature, and the critical dew point spread (TP_{Crit}) with at least one of: the visual image and the infrared image, and wherein the overlay is shown on the display.

11. The device as recited in claim 10, wherein the overlay is displayed in such a way that at least one of: the visual image and the infrared image is optically highlighted section by section, by using colors and by flashing.

12. The device as recited in claim 2, wherein at least one of: the air humidity device the air temperature device are connected to the system through a radio link.

13. A method for determining surface moisture of a surface, comprising:
determining the surface temperature using an infrared radiation measuring unit;
determining room dew point; and ascertaining the surface moisture from the room dew point and the surface temperature.

14. The method as recited in claim 13, wherein in order to determine the room dew point first air humidity and air temperature is determined and then the room dew point is ascertained from the air-humidity and the air temperature.

15. The method as recited in claim 13, wherein when a critical value for the surface moisture is exceeded, a warning signal is produced.

16. The method as recited in claim 15, wherein the critical value for the surface moisture is 80%.

17. The method as recited in claim 15, wherein a critical surface temperature is determined from the critical value for the surface moisture and the room dew point.

18. The method as recited in claim 17, wherein a critical dew point spread is determined from the critical surface temperature and the surface temperature.

19. The method as recited in claim 13, wherein at least one of: a visual image and an infrared image is taken of the surface.

20. The method as recited in claim 13, further comprising:
displaying on a display at least one of: air humidity air temperature, the surface temperature, the room dew point, the established surface moisture, a critical surface temperature, a critical dew point spread, a visual image and an infrared image.

21. The method as recited in claim 20, wherein an overlay of at least one of: the surface moisture, the critical surface temperature and the critical dew point spread is presented with at least one of: the visual image and the infrared image, which are shown on the display.

22. The method as recited in claim 21, wherein the overlay is created in such a way that at least one of: the visual image and the infrared image is optically highlighted section by section, by using colors or by flashing.

23. A device for determining dew point spread of a surface, comprising:
a dew point device for determining room dew point;
a third device for determining surface temperature using an infrared radiation measuring unit;
a system for providing the dew point spread from the room dew point and the surface temperature;
an optical camera for providing a visual image; and
a display, wherein the system provides an overlay of the dew point spread using the visual image which is presented on the display.

24. The device as recited in claim 23, wherein the dew point device has an air humidity device for determining air humidity and air temperature device for determining air temperature and the system determines the room dew point from the air humidity and the air temperature.

25. The device as recited in claim 23, wherein the overlay is produced by the system in such a way that the visual image is highlighted optically section by section by using color or flashing.

26. The method for determining dew point spread of a surface, comprising:
determining room dew point;
determining surface temperature using an infrared radiation measuring unit;
ascertaining the dew point spread from the room dew point and the surface temperature;
providing a visual image; and
providing an overlay of the dew point spread with the visual image.

27. The device as recited in claim 26, wherein for determining the room dew point first air humidity and air temperature are provided and then the room dew point is established from the air humidity and the air temperature.

28. The device as recited in claim 26, wherein the overlay is created in such a way that the visual image is highlighted optically section by section by using color or flashing.
